(19) United States
(12) Patent Application Publication
(10) Pub. No.: US 2011/0155315 A1
(43) Pub. Date: Jun. 30, 2011

(54) PRESERVATIVE-TREATED I-JOIST AND COMPONENTS THEREOF

(75) Inventor: Michael R. Von Pinnon, Beaverton, OR (US)

(73) Assignee: Ali'i Pacific LLC, McMinnville, OR (US)

(21) Appl. No.: 12/647,186

(22) Filed: Dec. 24, 2009

(51) Int. Cl. B32B 38/04; B29C 65/48

(52) U.S. Cl. 156/257; 156/281; 156/275.5

(57) ABSTRACT

A preservative-treated I-joist is produced by providing a web member and first and second flange members made of lignocellulosic material. Prior to assembly of the I-joist, a waterborne preservative is applied to the web and flange members, and thereafter the web and flange members are sized. The web and flange members may have a tongue-and-groove configuration for connecting the flange members to the web member. Sizing the web and flange members may include cutting one or more stocks of lignocellulosic material to produce the web and flange members, cutting grooves in the flange members, and trimming edge regions of the web member to form tongue portions to fit in the grooves. After the web and flange members are sized, the flange members are adhered to the web member to secure the web member and the flange members together.

### TECHNICAL FIELD

The field of the present disclosure relates generally to lignocellulosic building materials and more particularly to preservative-treated I-joists and methods of producing preservative-treated I-joists and components thereof.

### BACKGROUND INFORMATION

I-joists have been used for years in the construction of buildings. For example, I-joists are used for floor joists. I-joists are designed to be relatively light in weight and yet support heavy loads. As suggested by their name, I-joists have cross sections in the shape of a capital letter “I” and include a top flange and a bottom flange adhered to opposite top and bottom edge regions of a web. The flanges and webs of I-joists are typically made of wood, including solid sawn wood or engineered wood such as oriented strand board (OSB), plywood, laminated veneer lumber (LVL), parallel strand lumber (PSL), or laminated strand lumber (LSL).

Wood, however, is prone to structural degradation due to insects, fungus, and the like. Moreover, wood I-joists are prone to quickly burn and collapse in fire conditions, which makes the job of firefighters extremely dangerous when dealing with a structure that includes wood I-joists.

A light organic solvent preservative (LOSP) is typically used for treating wood I-joists after the web and flanges of the I-joists are assembled and adhered together. In LOSPs, a preservative to deter insect infestation is carried in a low volatile organic compound (VOC) mineral spirit solvent. The present inventor has recognized that LOSPs tend to be relatively expensive, odorous, and more harmful to the environment compared to waterborne preservatives. However, waterborne preservatives are not suitable for I-joists due to undesirable swelling and strength reduction of the I-joists.

### SUMMARY OF THE DISCLOSURE

According to one embodiment, a preservative-treated I-joist is produced by providing a web member and first and second flange members made of lignocellulosic material. The web member may include multiple web portions adhered together end to end, and the first and second flange members may include multiple flange portions adhered together end to end. Prior to assembly of the I-joist, a waterborne preservative is applied to the web member and flange members. Various types of waterborne preservatives and methods for applying the waterborne preservatives are described herein.

After the waterborne preservative is applied to the web member and flange members and dried, the web member and flange members are sized to desired sizes. The web member and flange members may have a tongue-and-groove configuration for connecting the flange members to the web member. Sizing the flange members and the web member may include cutting one or more stocks of lignocellulosic material to produce the flange members and the web member. For example, grooves may be cut (e.g., routed) in the flange members and edge regions of the web member may be trimmed to form tongue portions to fit in the grooves. After the web member and flange members are sized, the flange members are adhered to the web member to thereby secure the web member and the flange members together.

According to another embodiment, preservative-treated I-joist members are produced by providing first and second stocks of lignocellulosic material. A waterborne preservative is applied to the stocks of lignocellulosic material and the stocks are dried. After drying, the stocks are sized to form elongate web and flange portions each having opposite ends. Sizing the stocks of lignocellulosic material involves cutting the stocks to form the web portions and the flange portions and optionally configuring the ends of the web portions and the flange portions so that the ends of like components can be mated with each other.

The web portions are adhered together end to end and the flange portions are adhered together end to end by applying adhesive to their ends and thereafter curing the adhesive to thereby form a web member and a flange member. The flange members and web member may be shaped to form tongues and grooves of complementary shapes to connect the flange members to the web member.

Additional aspects and advantages will be apparent from the following detailed description of preferred embodiments, which proceeds with reference to the accompanying drawings.

### BRIEF DESCRIPTION OF THE DRAWINGS

FIG. 1 is a perspective view of an I-joist according to one embodiment.

FIG. 2 is a cross sectional view of the I-joist of FIG. 1.

FIG. 3 is a block diagram of a method for producing the I-joist of FIG. 1.

FIG. 4 is a pictorial view of representations of stocks of lignocellulosic material used for components of the I-joist of FIG. 1.

FIG. 5 is a block diagram of a full-cell process that may be implemented to treat the components of the I-joist of FIG. 1.

FIG. 6 is a block diagram of a modified full-cell process that may be implemented to treat the components of the I-joist of FIG. 1.

FIG. 7 is an isometric view of a web portion of the I-joist of FIG. 1.

FIG. 8 is an isometric view of a flange portion of the I-joist of FIG. 1.

FIG. 9 is a partial exploded isometric view of the I-joist of FIG. 1.

FIG. 10 is a side elevation view of an open web truss according to one embodiment.

### DETAILED DESCRIPTION OF PREFERRED EMBODIMENTS

With reference to the above-listed drawings, this section describes particular embodiments and their detailed construction and operation. The embodiments described herein are set forth by way of illustration only and not limitation. Those skilled in the art will recognize in light of the teachings herein that there is a range of equivalents to the example embodiments described herein. Most notably, other embodiments are possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

According to an embodiment, a preservative-treated I-joist is made according to a unique combination of processing steps to ensure that the resultant preservative-treated I-joist is environmentally friendly yet structurally sound. A high quality and environmentally safe preservative-treated I-joist is produced in part by subjecting I-joist components (e.g., web member, flange members) to a series of specially designed treatment and post-treatment processing steps prior to assembly of the I-joist. Through these processing steps, strength reduction that ordinarily occurs when environmentally friendly preservatives, such as waterborne preservatives, are applied to wood may be appreciably avoided so that the I-joist may be used to support heavy loads.

The processing steps may include treating the components (or optionally treating stocks of lignocellulosic material from which the components will later be formed) with a waterborne preservative prior to adhering the components together. The components may be dried after being treated with the preservatives.

After the components are treated and optionally dried, the components are sized to desired dimensions. Sizing the components after the preservative is applied and dried may help to ensure that the components have proper dimensions prior to assembly of the I-joist. Sizing the components may include cutting the web member and flange members to desired dimensions, forming grooves in the flange members, and forming tongue portions along top and bottom edge regions of the web member. Adhesive is applied to the sized components, the sized components are assembled, and the adhesive is cured to form the I-joist.

The above processing steps allow an I-joist to be treated with one or more waterborne preservatives—preservatives that are typically less expensive and more environmentally friendly than known preservatives used to treat I-joists. Specifically, producing an I-joist according to the above method may reduce some of the negative effects that typically occur when waterborne preservatives are applied to wood. For example, substantial degradation of the structural integrity of the I-joist due to swelling of the lignocellulosic material and/or adhesive breakdown, which might otherwise be induced by post-assembly application and curing of a waterborne preservative, may be diminished or avoided. Moreover, according to the above processing steps, an I-joist may be effectively treated with a fire retardant to deter rapid breakdown during fire conditions. Other advantages will be apparent to skilled persons from reading this disclosure.

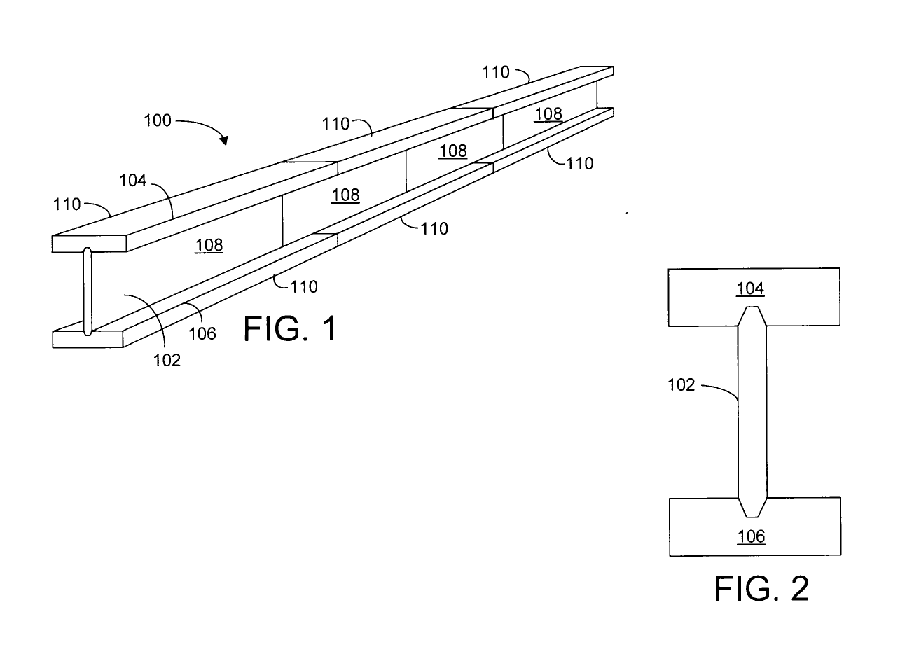

FIG. 1 is a perspective view of an I-joist 100 according to one embodiment. The I-joist 100 includes a web member 102 interposed between a first flange member 104 and a second flange member 106 to form an “I” shaped cross section as shown in FIG. 2. The web member 102 and flange members 104 and 106 are made of lignocellulosic material. The web member 102 may be made of solid sawn lumber or an engineered wood product (EWP) such as, but not limited to, OSB, plywood, flake board, fiberboard, hardboard, LVL, LSL, or PSL. The flange members 104 and 106 may also be made of solid sawn lumber or an EWP such as, but not limited to, LVL, LSL, PSL, OSB, plywood, flake board, fiberboard, or hardboard. The web member 102 and flange members 104 and 106 are treated with one or more preservatives for protection against breakdown or structural degradation. For example, preservatives such as pesticides, chemicals that deter insect infestation, and/or fire retardants may be applied to the web member 102 and flange members 104 and 106. Different preservatives that may be used are described below. The I-joist 100 may be used in floor systems, roof systems, or in other applications in which I-joists are commonly used.

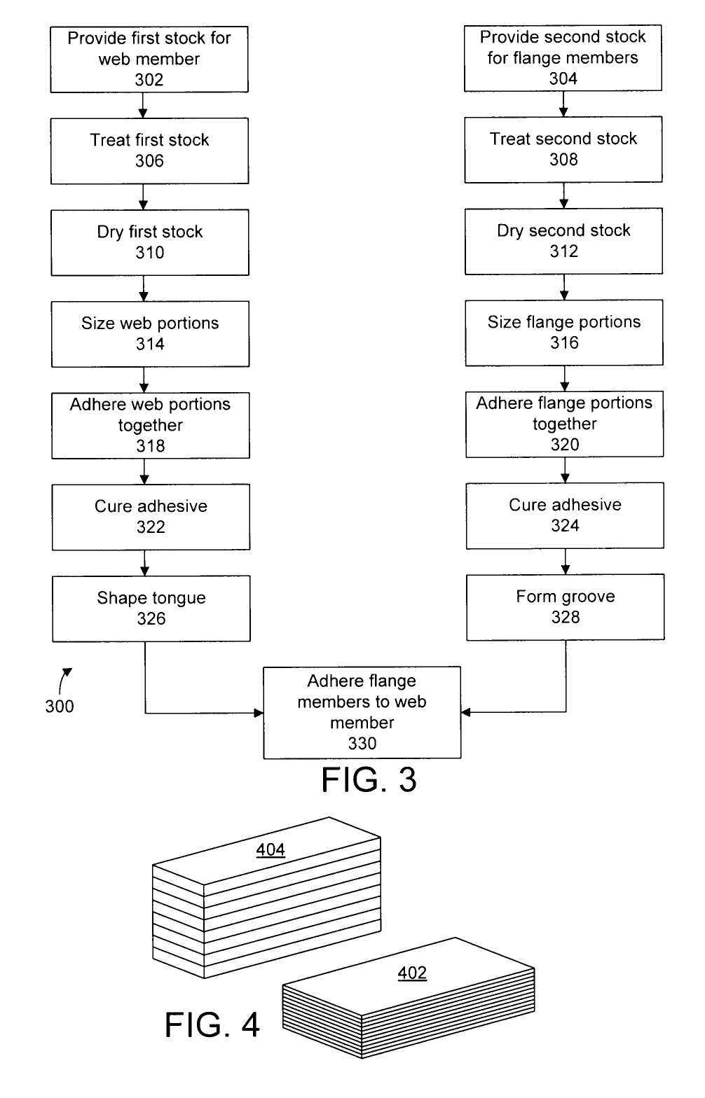

The I-joist 100 will now be described in more detail with reference to FIGS. 3-9. FIG. 3 is a block diagram of a method 300 of treating and assembling the I-joist 100 according to one embodiment. A first stock of lignocellulosic material for the web member 102 is provided and a second stock of lignocellulosic material for flange members 104 and 106 is provided (steps 302 and 304). In a preferred embodiment, the first stock for the web member 102 may be an EWP such as, but not limited to OSB, plywood, flake board, fiberboard, or hardboard. In an alternative embodiment (not shown), the first stock comprises a synthetic composite material such as fiberglass, nylon, steel, carbon fiber, fiber reinforced polyester, woven polyethelene, or combinations thereof to reinforce the web member 102. In a preferred embodiment, the second stock for the flange members 104 and 106 may be solid sawn lumber or may be an EWP such as, but not limited to, LVL, LSL, or PSL. FIG. 4 illustrates a first stock 402 of lignocellulosic material and a second stock 404 of lignocellulosic material. The first and second stocks 402 and 404 may each include one or more boards and/or planks of lignocellulosic material (multiple boards and planks are shown in FIG. 4).

The first and second stocks 402 and 404 are treated with one or more preservatives (steps 306 and 308). The stocks 402 and 404 may be treated with the same preservative or different preservatives, and more than one preservative may be applied to each of the stocks 402 and 404. Preferably, the stocks 402 and 404 are treated with a waterborne preservative in which water is used as a carrier. A number of different preservatives are described in more detail below. The first and second stocks 402 and 404 may be treated using one or more various treatment processes. For example, spray, dip, brush, roll-on, hot/cold soak, immersion, vacuum and pressure applications, or a combination of these different techniques may be used to apply the preservatives.

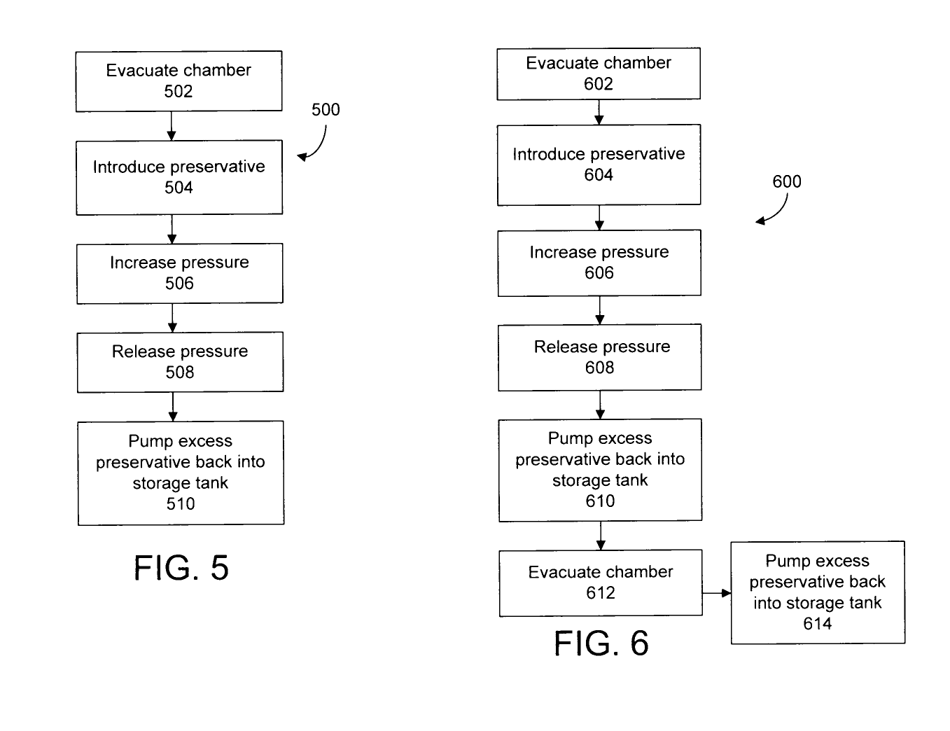

FIG. 5 is a block diagram of a full-cell (a.k.a. Bethell) vacuum and pressure process 500 that may be used to treat the stocks 402 and 404. Alternatively, a modified full-cell vacuum and pressure process 600 shown in block diagram form in FIG. 6 may be used to treat the stocks 402 and 404. In the full-cell process 500 and modified full-cell process 600, the stocks 402 and 404 are loaded into one or more treatment chambers. The stocks 402 and 404 may be put in the same chamber together and treated at the same time, or the stocks 402 and 404 may be put in different chambers (or the same chamber at different times) and treated separately. Preferably, different types of wood products are treated separately. In other words, it is preferable to treat like lignocellulosic material together (e.g., LVL with LVL, plywood with plywood) to achieve a somewhat uniform distribution of the preservative in the lignocellulosic material. The chamber for treating the lignocellulosic material has different connections to allow preservative to be introduced into and evacuated from the chamber and to add air into or remove air from the chamber to change the pressure inside it. For example, a storage tank for holding the preservative is connected to the chamber so that the preservative can flow between the storage tank and the chamber. Moreover, a pump such as a pneumatic or hydraulic pump is connected to the chamber to pump air out of and/or into the chamber. The chamber may be sized to accommodate large volumes of lignocellulosic material. In one example, the chamber can hold about 23 m³ of lignocellulosic material.

In the full-cell process 500, after one or more of the stocks 402 and 404 are loaded into the chamber, the chamber is sealed and evacuated to remove air from the lignocellulosic material prior to introduction of the preservative (step 502). For example, the chamber may be evacuated to a pressure in the range from about atmospheric pressure (101.3 (kPa) or 29.9 inches of mercury (inHg)) to about 92 kPa below atmospheric pressure (i.e., about 27 inHg below atmospheric pressure). In one example, the chamber is evacuated to a pressure in the range from about 34-92 kPa below atmospheric pressure (i.e., 10-27 inHg below atmospheric pressure), preferably to about 74.4 kPa below atmospheric pressure (i.e., about 22 inHg below atmospheric pressure). The vacuum may be maintained for about 5-10 minutes and perhaps several hours. In one example, the vacuum is maintained for about 30 minutes. The pressure level and its duration during step 502 depend on the specie, density, initial moisture content, and volume of the lignocellulosic material being processed.

Next, the preservative, which is suspended in a liquid carrier and stored in a storage tank, is introduced into the chamber (step 504). For example, the chamber is flooded with the preservative so that the lignocellulosic material is immersed in it. Flow meters or calibrated gauges may be used to meter the amount of preservative introduced into the chamber. The temperature of the preservative may be at about an ambient temperature (e.g., approximately 20° C.), or the preservative may be heated to a temperature greater than ambient, for example within a range of slightly above ambient to about 100° C. Once the preservative is introduced into the chamber, the pressure of the chamber is increased to a pressure in the range of about 515-1,380 kPa above atmospheric pressure (i.e., about 75-200 psi above atmospheric pressure) to force the preservative into the lignocellulosic material (step 506). The increased pressure period may be maintained from as little as 1-2 minutes to several hours depending on the specie and density of the lignocellulosic material being processed. In one example, the pressure period lasts from about 18-22 hours, and in another example, the pressure period lasts about 36 hours. The pressure level and its duration during step 506 depend on the volume of lignocellulosic material put in the chamber. The pressure is then gradually decreased to atmospheric pressure (step 508). Excess preservative is drained from the chamber and pumped back into the storage tank for further use (step 510). The full-cell process may be used when a high preservative retention is desired. For example, full-cell treatments can achieve preservative absorptions in excess of 400 kg/m³ or up to 2.5 gallons of preservative per cubic foot of wood.

With reference to FIG. 6, in the modified full-cell process 600, after one or more of the stocks 402 and 404 are loaded into the chamber, the chamber is sealed and evacuated to remove air from the lignocellulosic material prior to introduction of the preservative (step 602). For example, the chamber may be evacuated to a pressure in the range from about 17 to 34 kPa below atmospheric pressure (i.e., about 5-10 inHg below atmospheric pressure), and preferably to about 27 kPa below atmospheric pressure (i.e., about 8 inHg below atmospheric pressure). The vacuum may be maintained for as little as 3-10 minutes and up to about 30 minutes depending on the specie, density, initial moisture content, and volume of the lignocellulosic material being processed.

Next, the preservative, which is suspended in a liquid carrier and stored in the storage tank, is introduced into the chamber (step 604). For example, the chamber is flooded with the preservative so that the lignocellulosic material is immersed in it. The temperature of the preservative may be at about an ambient temperature (e.g., approximately 20° C.), or the preservative may be heated to a temperature greater than ambient, for example within a range of slightly above ambient to about 100° C. Once the preservative is introduced into the chamber, the pressure of the chamber is increased to a pressure in the range of about 515-1,380 kPa above atmospheric pressure (i.e., about 75-200 psi above atmospheric pressure) to force the preservative into the lignocellulosic material (step 606). The increased pressure period may be maintained from a few minutes to 20 hours. The pressure level and its duration during step 606 depend on the volume of lignocellulosic material put in the chamber. The pressure is then decreased to atmospheric pressure (step 608). Excess preservative is then drained from the chamber and pumped back into the storage tank for further use (step 610). A second vacuum cycle is then initiated to force some of the preservative out of the lignocellulosic material (step 612). The vacuum pressure during the second vacuum cycle may be more intense than the initial vacuum step 602, and the second vacuum cycle may be of a longer duration than that of the initial vacuum step 602. For example, the pressure may be in the range of about 88 to 95 kPa below atmospheric pressure (i.e., about 26 to 28 inHg below atmospheric pressure) during the second vacuum cycle, which may be maintained from 20-30 minutes to about 2-3 hours. The preservative that is forced out of the lignocellulosic material during the second vacuum cycle is drained from the chamber and pumped back into the storage tank for further use (step 614). The stocks 402 and 404 will tend to be drier and lighter after treatment using the modified full-cell process 600 compared to the full-cell process 500 because the second vacuum cycle removes excess liquid carrier from the lignocellulosic material.

Turning again to FIG. 3, after the stocks 402 and 404 are treated, the stocks are dried (steps 310 and 312). Drying the stocks 402 and 404 may include an initial drip dry step in which preservative drippings are collected and reintroduced into the storage tank for further use. During the drip dry step, samples may be taken from the stocks 402 and 404 to determine depth of penetration and retention of the preservative. After the drip dry step, spacers (kiln sticks) may be placed between individual pieces of the stocks 402 and 404, and the stocks 402 and 404 may optionally be kiln dried. The stocks 402 and 404 may be kiln dried together, or, preferably, at different times. The dry bulb temperature of the kiln may be between about 51° C. and about 71° C. The stocks 402 and 404 are kiln dried until the average moisture contents of the stocks 402 and 404 are below about 14% by weight, preferably in the range from about 12% by weight to about 14% by weight. Moisture contents can be ascertained from oven dry weight samples according to ASTM D4442-07 or by using resistance pin type or dielectric moisture meters. Typically, pin type meters are used for sawn lumber and dielectric meters are used for engineered wood items. The stocks 402 and 404 are then removed from the kiln and allowed to cool to an ambient temperature. Although drip drying and kiln drying have been described, other methods of drying may be employed such as air seasoning, vacuum drying, infrared, dehumidification, vacuum/radio frequency, forced air drying, or combinations thereof.

After drying, the stocks 402 and 404 are sized to form the components of the I-joist 100 (steps 314 and 316). For example, one or more boards of the first stock 402 are cut (e.g., ripped, cross cut) to desired dimensions (e.g., width, length, thickness) to form web portions that will be adhered together to form the web member 102 (e.g., four web portions 108 are shown in FIG. 1), and one or more planks of the second stock 404 are cut (e.g., ripped, cross cut) to desired dimensions (e.g., width, length, thickness) to form flange portions that will be adhered together to form the flange members 104 and 106 (six flange portions 110 are shown in FIG. 1).

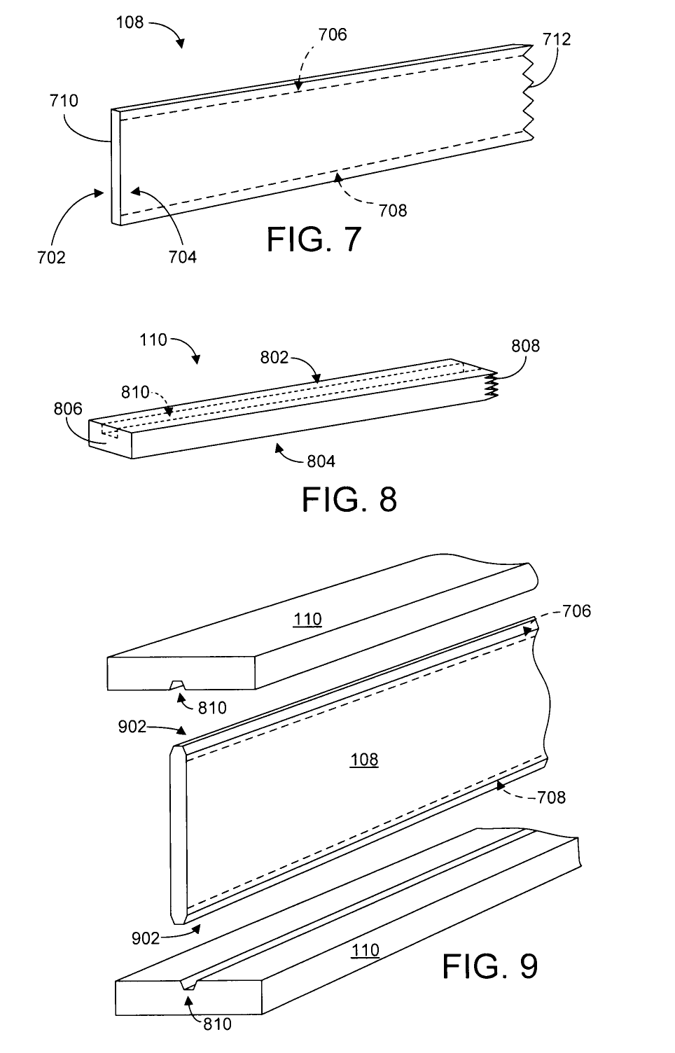

FIG. 7 is a three-dimensional view of a web portion 108. The web portion 108 has two major opposing faces 702 and 704, top and bottom edge regions 706 and 708, and opposing ends 710 and 712. During the sizing step 314, one or both of the opposing ends 710 and 712 may be configured so that the web portion 108 can be securely adhered to other web portions 108 end to end to form the web member 102. For example, one or more of the ends 710 and 712 may be cut to form a scarf joint connection, finger joint connection, butt joint connect, tongue-and-groove connection, or the like. FIG. 7 shows end 712 configured for a finger joint connection. During the sizing step 314, the top and bottom edge regions 706 and 708 may also be shaped (e.g., cut, trimmed) to form tongue portions. Alternatively, the tongue portions may be formed later as described below.

FIG. 8 is a three-dimensional view of a flange portion 110. The flange portion 110 has opposing faces 802 and 804 and opposing ends 806 and 808. As with the web portion 108, during the sizing step 316, one or both of the opposing ends 806 and 808 of the flange portion 110 may be configured (e.g., a scarf joint connection, finger joint connection, butt joint connection, tongue-and-groove connection, or the like) so that the flange portion 110 can be securely adhered to other flange portions 110 end to end to form one of the flange members 104 and 106. FIG. 8 shows end 808 configured to form a finger joint connection. During the sizing step 316, a groove 810 may be formed (e.g., cut, routed) along the face 802 or the face 804. Alternatively, the groove 810 may be formed later as described below.

After the stocks 402 and 404 are sized, adhesive is applied to the ends of the web portions 108 and the flange portions 110, the web portions 108 are joined together end to end, and the flange portions 110 are joined together end to end (steps 318 and 320). Various types of adhesive may be used to adhere the web portions 108 together and the flange portions 110 together. Preferably, the adhesive is a heat resistant adhesive (HRA). For example, the adhesive may include liquid phenol-resorcinol-formaldehyde. One suitable adhesive is a HexiTherm™ AG series adhesive available from Hexion™ Specialty Chemicals, Inc. of Columbus, Ohio. Another suitable adhesive is an ISOSET® adhesive available from Ashland Inc. of Columbus, Ohio. Other suitable adhesives available from a wide variety of companies may also be used. The adhesive may further include a crosslinker or hardener such as a formaldehyde or para-formaldehyde hardener. One suitable crosslinker an ISOSET® crosslinking agent available from Ashland Inc. A ratio of hardener to adhesive may vary depending on desired cure times and glue durability. In one example, the ratio of hardener to adhesive may be about 5-20 parts of hardener to about 100 parts of adhesive by weight. Fasteners may also be used in addition, or as an alternative, to the adhesive to hold the web portions 108 and the flange portions 110 together.

After the adhesive is applied and the ends of the web and flange portions 108 and 110 and like components are joined together, the adhesive is cured (steps 322 and 324). The adhesive may be cured using hot press curing, radio frequency curing, or cold press curing depending on the cure times desired. Preferably, a press is used during steps 318, 320, 322, and 324 to assure good contact between the web portions 108 and the flange portions 110. In one example, hot press curing may be used in which the press' platen temperature is about 87-103° C. and the adhesive's glue-line temperature reaches about 82-88° C. and is maintained at that temperature for about 30 seconds or longer. In another example, radio frequency press curing may be used in which the adhesive's glue-line temperature reaches about 48-83° C. Typically, the press time used during radio frequency press curing is relatively short (e.g., about 30 seconds to 2 minutes) and the frequency used is in a range from 3-30 megahertz (MHz) (e.g., 6.78 MHz, 13.56 MHz, or 27.12 MHz).

After the adhesive is cured, the top and bottom edge regions 706 and 708 of the web portions 108 are shaped to form tongue portions and the grooves 810 are formed along one of the faces 802 and 804 of the flange portions 110 (steps 326 and 328). Alternatively, steps 326 and 328 may be omitted if the tongue portions and the grooves 810 were formed previously during the sizing steps 314 and 316. FIG. 9 is a partial exploded three-dimensional view of the web portion 108 and flange portions 110 showing tongue portions 902 formed along the top and bottom edge regions 706 and 708 of the web portion 108 and the grooves 810 formed along the faces 802 and 804 of the flange portions 110. The tongue portions 902 and grooves 810 are of complementary shape to provide a secure fit of the tongue portions 902 in the grooves 810. For example, the tongue portions 902 and grooves 810 may be shaped (e.g., profiled) to provide sufficient contact area between the web member 102 and flange members 104 and 106 so that longitudinal shear stresses are transferred between the web and flange members 102, 104, and 106. Many different tongue-and-groove shapes are known and may be used to connect the web member 102 to the flange members 104 and 106.

After the tongue-and-groove connections for the web member 102 and flange members 104 and 106 are formed, the flange members 104 and 106 are adhered to the web member 102 by applying adhesive to the tongue-and-groove connections and seating the tongue portions 902 their corresponding grooves 810 (step 330). The adhesive and hardener used to connect the web member 102 to the flange members 104 and 106 may be the same types of adhesive and hardener that were used in steps 318 and 320 for the web-to-web connections and flange-to-flange connections. The web member 102 and flange members 104 and 106 may be held together tightly by a press while the adhesive cures. The adhesive may be cured using hot press curing, radio frequency curing, or ambient curing. Fasteners may also be used to reinforce the web-to-flange connections.

According to the foregoing method 300, the I-joist 100 may be effectively treated with a waterborne preservative, and yet be structurally sound. For example, the structural capacity of the I-joist 100 may meet and/or surpass structural standards set forth in ASTM D5055-08a. The method 300 may appreciably compensate for swelling and/or distortion of the lignocellulosic material that typically occurs when a waterborne preservative is applied. Use of LOSPs, which are typically applied to I-joists, may be avoided.

The method 300 allows the I-joist 100 to be treated with many different types of preservative that are not conventionally used with I-joists due to undesirable strength reduction of the I-joists. Different waterborne preservatives may be used such as, but not limited to, borates, micronized copper, copper amines, copper azoles, copper hydroxides, carbon based preservatives, fixed arsenicals, and fire retardants. The preservative may include one or more of the following: disodium octaborate tetrahydrate (DOT); micronized copper quat (MCQ); micronized copper azole (MCA); amine copper quaternary (ACQ); propiconazole-tebuconazole-imidacloprid (PTI); dichloro-octal-isothiazolin (DCOIT); chromated copper arsenate (CCA); ammoniacal copper arsenate (ACA); ammoniacal copper zinc arsenate (ACZA); phosphates; urea, dicyandiamide, phosphoric acid, and formaldehyde (UDPF); melamine, dicyandiamide, phosphoric acid, and formaldehyde (MDPF); dicyandiamide, phosphoric acid, and formaldehyde (DPF); boric acid; Huntite (3MgCO₃×CaCO₃); Hydromagnesite (Mg₅(CO₃)₄(OH)₂×4H₂O); metal hydroxides; chlorinated paraffins; and bromated compounds.

Examples of waterborne preservative products that may be used to treat the I-joist 100 include Advance Guard®, Hi-Bor®, MicroPro® MCQ, MicroPro® MCA, NatureWood®, Osmose K-33®, and FirePRO® produced by Osmose®, Inc. of Buffalo, N.Y.; Timbor® Industrial produced by U.S. Borax Inc. of Greenwood Village, Colo.; TimberSaver®40, TimberSaver® PT, Preserve®, Ecolife™, SupaTimber®, and D-Blaze® produced by Viance™ of Charlotte, N.C.; SilBor®, Wolmanized® Residential Outdoor®, Wolmanized® L³ Outdoor®, Original Wolmanized® Heavy-Duty™, Chemonite®, Dricon®, and FRX® produced by Arch Chemicals, Inc. of Norwalk, Conn.; EnviroSafe Plus® produced by Wood Treatment Products, Inc. of Lake Mary, Fla.; TimberSIL® produced by TimberSIL® Products of Springfield, Va.; PhibroWood-CQ™ and Sustain™ produced by Phibro Wood, LLC of Ridgefield Park, N.J.; Protectol CX™ produced by BASF Corporation of Florham Park, N.J.; PYRO-GUARD® and Exterior Fire X® produced by Hoover Treated Wood Products, Inc. of Thompson, Ga.; and fire retardants produced by Fire Smart Roofing Treatment, Inc. of Mission, British Columbia, Canada.

Additionally, a preservative-buffer-penetration (PBP) enhancer may be applied to the web member 102 and flange members 104 and 106 according to method 300. Examples of PBP enhancer products include Tru-Core® produced by Kop-Coat, Inc. of Pittsburgh, Pa.; FrameGuard® produced by Arch Chemicals, Inc.; Bluewood® produced by Conrad Forest Products of North Bend, Oreg.; and QuanTIM™ produced by Viance™ PBP enhancers are preferably applied to the stocks 402 and 404 using a spray, dip, brush, or roll-on application.

Non-waterborne preservatives may also be applied according to the method 300. For example, liquid dispersible preservatives such as zinc borate may be applied as a dry powder to the web member 102 and/or flange members 104 and 106. Boroguard® ZB produced by U.S. Borax Inc. of Valencia, Calif. is one example of a zinc borate preservative that may be used. Preferably, zinc borate is applied to the web member 102 when OSB is used for the web member 102. LOSPs such as propiconazol-tebucanazol-permitherin (PTP); permitherin and 3-iodo-2-propynyl butyl carbamate (IPBC) (PI); and chlorpyrophos and IPBC (CI) may also be applied according to the method 300. Examples of LOSP products that may be used include Bodyguard® produced by Bodyguard Wood Products Ltd. of Moteuka Tas, New Zealand; Hi-Clear II™ produced by Permapost Products Co. of Hillsboro, Oreg.; and Tribucide II™ produced by Kop-Coat, Inc.

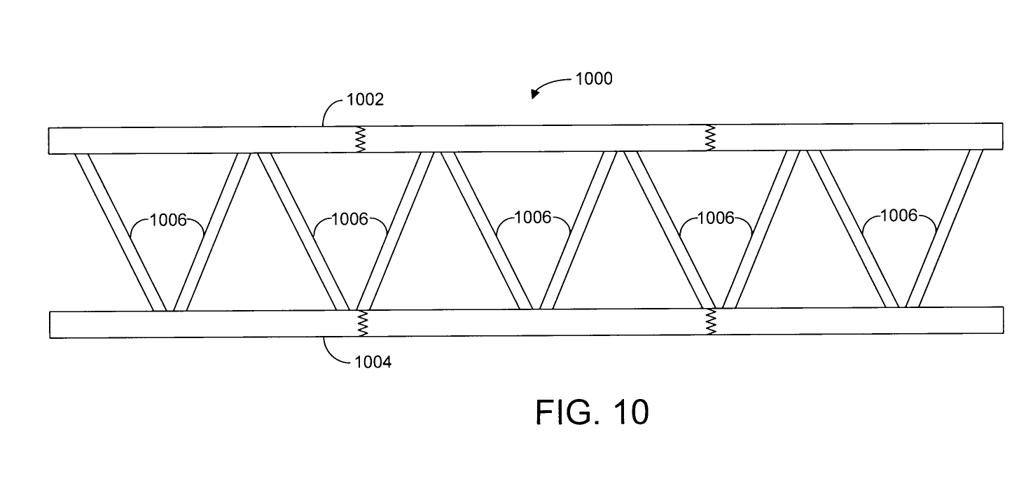

Aspects of the methods of treating I-joists described above may be applicable to other engineered wood structures. For example, parts of an open web truss that are made of lignocellulosic material may be treated with a preservative prior to assembly of the open web truss. FIG. 10 is a side view of an open web truss 1000 that includes flange members 1002 and 1004 and multiple web segments 1006 positioned between the flange members 1002 and 1004. Similar to the flange members 104 and 106, the flange members 1002 and 1004 are made of lignocellulosic material such as solid sawn lumber, LVL, LSL, or PSL. The web segments 1006 may be made of lignocellulosic material or another material such as metal and/or a composite material. The web segments 1006 are connected to the flange members 1002 and 1004 via fasteners (e.g., nails, screws, nuts and bolts) and/or adhesive such as a HRA described above. However, prior to assembly, the flange members 1002 and 1004 are treated with one or more preservatives described above. Moreover, when the web segments 1006 are made of lignocellulosic material, they may also be treated with one or more preservatives prior to assembly. For example, steps 308, 312, 316, 320, and 324 described above may be implemented to produce the flange member 1002 and 1004. Additionally, when lignocellulosic material is used for the web segments 1006, the lignocellulosic material for the web segments 1006 may be treated with a preservative, dried, and sized according to the methods described above prior to assembly of the open web truss 1000.

It will be obvious to those having skill in the art that many changes may be made to the details of the above-described embodiments without departing from the underlying principles of the invention. The scope of the present invention should, therefore, be determined only by the following claims.

1. A method of producing an I-joist, comprising:
(a) providing a web member made of lignocellulosic material;
(b) providing first and second flange members made of lignocellulosic material;
(c) applying a waterborne preservative to the web member and the first and second flange members;
(d) after step (c), sizing the web member and the first and second flange members, the first flange member having a first groove to receive a first tongue portion of the web member, and the second flange member having a second groove to receive a second tongue portion of the web member;
(e) after step (d), seating the first tongue portion in the first groove and the second tongue portion in the second groove; and
(f) adhering the first tongue portion to the first flange member and the second tongue portion to the second flange member to thereby secure the web member and the first and second flange members together.

2. The method of claim 1, wherein step (c) comprises:
(g) applying a first waterborne preservative to the web member; and
(h) applying a second waterborne preservative to the first and second flange members.

3. The method of claim 2, wherein step (h) is performed separately from step (g).

4. The method of claim 1, wherein the waterborne preservative includes boron.

5. The method of claim 1, wherein the waterborne preservative includes a pesticide.

6. The method of claim 1, wherein the waterborne preservative includes a fire retardant.

7. The method of claim 1, wherein step (c) comprises:
(g) reducing pressure within a processing chamber to a pressure level below atmospheric pressure, at least one of the web and first and second flange members being positioned in the processing chamber; and
(h) introducing the waterborne preservative in the processing chamber.

8. The method of claim 7, wherein step (c) further comprises:
(i) pressurizing the processing chamber to a pressure level above atmospheric pressure to thereby force some of the waterborne preservative into said at least one of the web and first and second flange members.

9. The method of claim 8, wherein step (c) further comprises:
(j) after step (i), reducing pressure in the processing chamber to a pressure level below atmospheric pressure to thereby force an excess amount of the waterborne preservative from said at least one of the web and first and second flange members.

10. The method of claim 1, further comprising:
(g) after step (c), drying the web member and the first and second flange members until they have a moisture content below about 14% by weight.

11. The method of claim 1, wherein the first and second flange members are formed from multiple elongate flange portions having opposite ends that are adhered together after the waterborne preservative is applied.

12. The method of claim 1, wherein the web member includes opposing major faces each having a top edge region and a bottom edge region, and step (d) includes trimming the top and bottom edge regions of the opposing major faces to form the first and second tongue portions.

13. The method of claim 1, wherein step (d) includes cutting the first groove in the first flange member and the second groove in the second flange member.

14. A method of producing I-joist members, comprising:
(a) providing first and second stocks of lignocellulosic material;
(b) applying a waterborne preservative to the first and second stocks of lignocellulosic material;
(c) after step (b), drying the first and second stocks of lignocellulosic material;
(d) sizing the dried first stock of lignocellulosic material to form a first elongate web portion having opposite first and second ends, the first end of the first web portion configured to mate with a first end of a second web portion;
(e) sizing the dried second stock of lignocellulosic material to form a first elongate flange portion having opposite first and second ends, the first end of the first flange portion configured to mate with a first end of a second flange portion;
(f) adhering the first and second web portions together end to end including applying a first adhesive to the first ends of the first and second web portions and thereafter curing the first adhesive to thereby form a web member, wherein the web member has a tongue portion;
(g) adhering the first and second flange portions together end to end including applying a second adhesive to the first ends of the first and second flange portions and thereafter curing the second adhesive to thereby form a flange member; and
(h) forming in the first and second flange portions a groove to receive the tongue portion of the web member.

15. The method of claim 14, wherein step (b) comprises:
(i) applying a first waterborne preservative to the first stock of lignocellulosic material; and
(j) applying a second waterborne preservative to the second stock of lignocellulosic material.

16. The method of claim 15, wherein step (j) is performed separately from step (i).

17. The method of claim 16, wherein the first and second stocks of lignocellulosic material are dried independently from each other.

18. The method of claim 14, wherein the waterborne preservative includes boron.

19. The method of claim 14, wherein the first and second flange portions are finger jointed together end to end to form the flange member.

20. The method of claim 14, wherein the first and second adhesives are cured using radio frequency curing.

21. The method of claim 14, wherein the first and second adhesives are cured by heating the first and second adhesives.

22. The method of claim 14, wherein step (e) comprises cutting the second stock to form the first and second flange portions.

23. The method of claim 14, wherein step (c) comprises drying the first and second stocks of lignocellulosic material until they have a moisture content below about 14% by weight.

24. The method of claim 14, wherein the first and second adhesives are heat resistant.

25. The method of claim 14, wherein the groove is formed in the first and second flange portions after the first and second flange portions are adhered together.

26. The method of claim 14, further comprising:
(i) seating the tongue portion in the groove; and
(j) adhering the tongue portion to the flange member to thereby secure the web member and the flange member together.

27. The method of claim 14, wherein step (b) comprises:
(i) reducing pressure within a processing chamber to a pressure level below atmospheric pressure, at least one of the first and second stocks of lignocellulosic material being positioned in the processing chamber; and
(j) introducing the waterborne preservative in the processing chamber.

28. The method of claim 27, wherein step (b) further comprises:
(k) pressurizing the processing chamber to a pressure level above atmospheric pressure to thereby force some of the waterborne preservative into said at least one of the first and second stocks of lignocellulosic material.

29. The method of claim 28, wherein step (b) further comprises:
(j) after step (i), reducing pressure in the processing chamber to a pressure level below atmospheric pressure to thereby force an excess amount of the waterborne preservative from said at least one of the first and second stocks of lignocellulosic material.

30. A method of producing an open web truss, comprising:
(a) providing a stock of lignocellulosic material;
(b) providing multiple web segments;
(c) applying a waterborne preservative to the stock of lignocellulosic material;
(d) after step (c), drying the stock of lignocellulosic material;
(e) sizing the dried stock of lignocellulosic material to form flange portions each having one or more ends configured to mate with an end of one or more of the other flange portions;
(f) adhering the flange portions together end to end to form the flange member, wherein a first adhesive is applied to mating ends of the flange portions and cured; and
(g) connecting the multiple web segments to the flange member to form an open web truss, in which ends of the multiple web segments are attached to the flange member and secured in place.
